(19) United States
(12) Patent Application Publication
(10) Pub. No.: US 2006/0068193 A1
(43) Pub. Date: Mar. 30, 2006

(54) Method and apparatus for making a trim panel with a self-skinning blown elastomer component

(75) Inventors: Glenn A. Cowelchuk, Chesterfield, MI (US); Todd DePue, Brighton, MI (US); Robert J. Adams, Ypsilanti, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/953,627

(22) Filed: Sep. 29, 2004

(51) Int. Cl. B32B 27/00

(52) U.S. Cl. 428/319.3; 428/318.8; 428/71; 428/76

(57) ABSTRACT

A method and apparatus for forming an interior component part having a relatively rigid substrate portion and a padded portion. The molding tool used to form the substrate portion includes a first mold part and a second mold part that form a substrate molding cavity into which a thermoplastic olefin is injected. The padded portion is formed by the first mold part and a third mold part that define a pad forming cavity. A mixture of a thermoplastic elastomer and a blowing agent is injected into the pad forming cavity. The expanded blown elastomer is enveloped within a skin formed when the blown elastomer contacts a cooled mold surface.

### BACKGROUND OF THE INVENTION

1. Field of the Invention

The present invention relates to a method of making an interior trim component, a mold for forming the interior component and the interior trim component that comprises a substrate portion and a padded cover portion having a smooth skin encompassing an expanded core. The smooth skin and core are made from the same mixture that forms the smooth skin where it contacts the mold and also forms the expanded core in the interior portions of the mold.

2. Background Art

Interior trim components for a vehicle may be formed from a variety of materials including cloth, plastic and leather. Many different manufacturing processes have been developed to provide desired surface textures, surface finishes and padding. Padded areas of vehicle interior components were originally formed by sewing fabric over composite padding material. This approach was replaced to a substantial extent by manufacturing processes wherein plastic skins were roto-cast in closed molds that were used to form shaped “balloon-like” enclosures that were then filled with expanded elastomer foam materials. This later developed roto-casting process resulted in substantial savings and facilitated the incorporation of advanced polymeric materials and production systems that reduced manufacturing expense.

Recently, one of the co-inventors of this application filed U.S. application Ser. No. 10/708,312 entitled “Two-Shot Co-Injected Automotive Interior Trim Assembly and Method” that was assigned to the assignee of the present application. This application disclosed the concept of manufacturing an automotive interior trim assembly in which a substrate member is formed by injecting one material into a mold after which second and third materials are co-injected through a coaxial port in a mold. The second material forms a skin layer while the third material forms a foam layer.

A disadvantage of this approach is that three materials must be provided to an injection molding machine. Costs associated with providing additional material and costs associated with maintenance, such as flushing three different materials and the need for a specialized three-component injection mold are disadvantages associated with the process disclosed in the prior application.

These and other problems and disadvantages are addressed by Applicants' invention as summarized below.

### SUMMARY OF THE INVENTION

According to one aspect of the present invention, a method of making an interior trim panel for a vehicle is disclosed. The method comprises injecting a first material into a first injection mold cavity that defines the shape of a substrate portion of the trim panel to form the substrate portion. A second material and a blowing agent are supplied to an injection molding machine. In the injection molding machine, the second material is melted under pressure and mixed with the blowing agent to form a self-skinning blown elastomer. The self-skinning blown elastomer is injected into a second injection mold cavity containing a previously formed substrate portion that also defines the shape of a padded portion of the trim panel. The self-skinning blown elastomer is injected into the cavity to form an elastomeric foam padded portion having a smooth skin on the exterior surface of the padded portion.

According to other aspects of the method of the present invention, the smooth skin portion of the elastomeric foam padded portion is formed upon contact with a relatively cool mold surface. The first material is a thermoplastic material that forms a relatively rigid substrate portion and may be a material selected from the group consisting of thermoplastic olefin, acrylonitrile butadiene styrene, styrene maleic anhydride, polycarbonate/acrylonitrile butadiene styrene alloy, and polypropylene. The second material may be a thermoplastic elastomer, such as polycarbonate or polypropylene.

According to other aspects of the invention as it relates to the method, a first injection mold cavity may have a first mold portion and a second mold portion that are moved relative to each other between an open position and a closed position. In the closed position, the shape of the substrate portion is defined and a thermoplastic olefin is injected to form a relatively rigid substrate. The second injection molding cavity may be formed by the first mold portion of the first injection mold, the previously formed substrate portion of the trim panel, and a third mold portion. A self-skinning blown elastomer is heated and injected into the second injection molding cavity to form a padded portion having a smooth skin.

Another aspect of the present invention relates to a mold for forming an interior component of a vehicle. The mold comprises a first injection mold having a first mold portion and a second mold portion that are moved relative to each other between an open position and a closed position. The shape of the substrate portion is defined by the first and second mold portions when they are in the closed position. The first mold portion has at least one port for injecting a first polymeric material. A second injection mold including the first mold portion of the first injection mold, the previously formed substrate portion of the trim panel and a third mold portion. The third mold portion has at least one port for injecting a mixture of a second polymeric material and a blowing agent that are melted and injected under pressure into the second injection mold. The mixture, after injection into the mold, forms a smooth skin upon contact with the cooled mold walls and a foam core as the blowing agent expands in the interior portion of the second injection mold.

According to other aspects of the invention, the first portion of the second injection mold cavity, while supporting the substrate portion, may be moved relative to the third portion between an open position and a closed position to define a cavity for the formation of an elastomeric foam padded portion. The mixture of the second polymeric material and the blowing agent are provided to an injection molding machine in solid form.

According to another aspect of the invention, a vehicle trim assembly is provided. The vehicle trim assembly comprises a substrate member onto which a padded cover member is integrally molded. The padded cover member has a smooth skin encompassing an expanded core. The material used to form the smooth skin and the core is a mixture of an elastomer and a blowing agent that are melted under pressure in an injection molding machine and provided to the mold where a smooth skin is formed upon contact with cooled mold walls and the expanded core is formed in the interior of the mold.

These and other aspects of the present invention will be better understood with reference to the attached drawings and the following detailed description of a preferred embodiment of the invention.

### BRIEF DESCRIPTION OF THE DRAWINGS

FIG. 1 is a cross-sectional view of a molding tool for forming a substrate portion of an interior trim component;

FIG. 2 is a cross-sectional view of a molding tool for forming a foam padded portion of an interior trim component showing an initial injection of a self-skinning elastomer;

FIG. 3 is a cross-sectional view of a mold for forming a padded portion of an interior trim component at the completion of the molding cycle; and

FIG. 4 is a cross-sectional view showing an interior trim component formed according to the disclosed method.

### DETAILED DESCRIPTION OF THE PREFERRED EMBODIMENTS

Referring to FIG. 1, a molding tool 10 is shown that comprises a first mold part 12 and a second mold part 14. The first mold part 12 and second mold part 14 form a substrate mold cavity 16. A thermoplastic olefin (TPO) port 18 is provided for injecting TPO 20 that is pumped from a source of TPO 22.

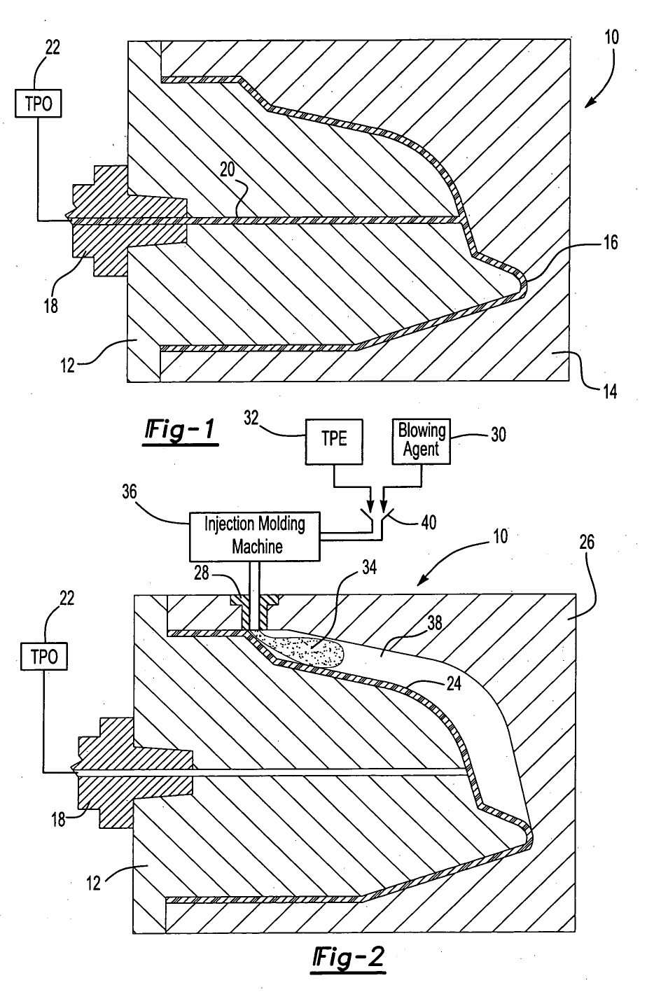

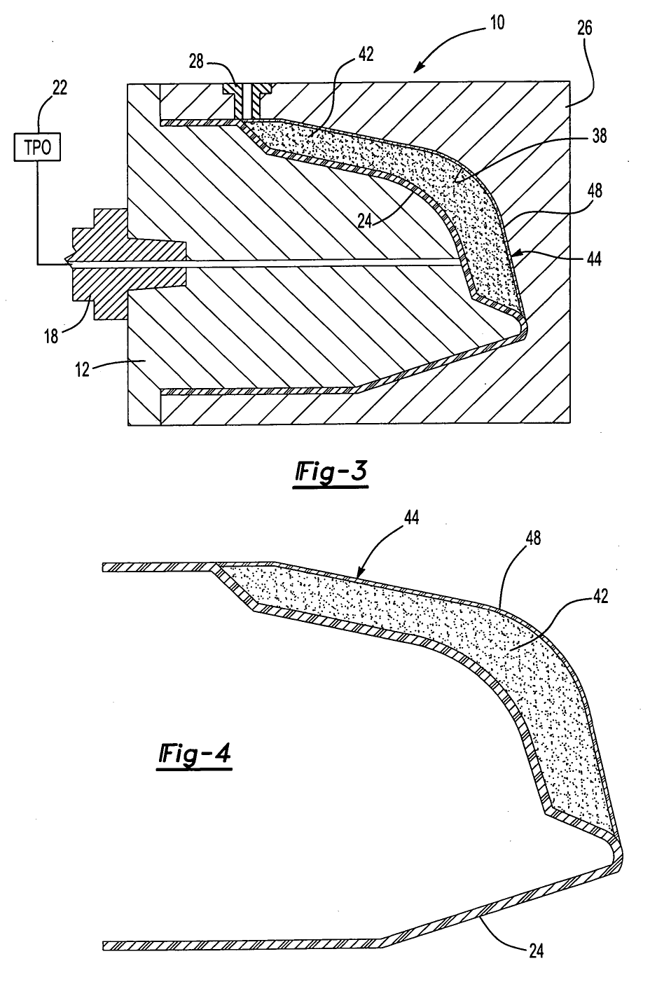

Referring to FIGS. 2 and 3, a molded substrate 24 is shown on the first mold part 12. A third mold part 26 is shown engaging the first mold part 12. The third mold part 26 has a thermoplastic elastomer (TPE) port 28 through which a molten mixture of a blowing agent 30 and TPE 32 are injected as a mixture 34. The mixture 34 is heated under pressure in an injection molding machine 36 into the pad forming cavity 38.

Depending upon part geometry, part size, and material selection, the temperature and pressure are determined. Typically, polycarbonate or polypropylene thermoplastic olefins would be heated to between 200° F. and 500° F. at pressures of between 1,000 and 20,000 psi. The blowing agent 30 and TPE 32 are supplied to the injection molding machine 36 through a feeder hopper 40 in solid or pellet form. After injection, this mixture 34 may be referred to as a self-skinning blown elastomer 42.

Blown elastomer 42 forms a padded portion 44 within the pad forming cavity 38. A skin 48 is formed by the blown elastomer 42 where it contacts the relatively cool mold part 26. The mold part may be cooled by circulating water or air cooled as is well known in the art.

The TPO may be acrylonitrile butadiene styrene, styrene maleic anhydride, polycarbonate/acrylonitrile butadiene styrene alloy, or polypropylene. The thermoplastic elastomer may be polycarbonate or polypropylene. Other thermoplastic elastomers may also be used provided that they form a smooth skin when forced into contact with the cool mold part 26. The blown elastomer 42 expands and is forced into contact with the cool mold part 26 that quicky cools the mixture 42 and forms a smooth skin before the blowing agent can expand substantially.

Referring to FIG. 4, a finished interior part is shown to include a substrate 24 and a pad portion 44 that includes the skin 48 encompassing the blown elastomer 42.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an interior trim panel for a vehicle comprising:
injecting a first material into a first injection mold cavity defining the shape of a substrate portion of the trim panel to form the substrate portion;
heating a mixture including a thermoplastic elastomer and a blowing agent under pressure in an injection molding machine;
injecting the mixture into a second injection mold cavity containing the substrate portion and defining the shape of a padded portion of the trim panel;
forming an elastomeric foam padded portion in the second injection molding cavity as the mixture expands upon relieving pressure on the mixture; and
forming a smooth skin on the surface of the mixture that contacts a relatively cool wall of the second injection molding cavity.

2. The method of claim 1 wherein the smooth skin portion of the elastomeric foam padded portion is formed upon contact with a cooled mold surface.

3. The method of claim 1 wherein the first material is a thermoplastic olefin that forms a relatively rigid substrate portion.

4. The method of claim 1 wherein the first material is selected from the group consisting of:
acrylonitrile butadiene styrene;
styrene maleic anhydride;
polycarbonate/acrylonitrile butadiene styrene alloy; and
polypropylene.

5. The method of claim 1 wherein the mixture of the thermoplastic elastomer and blowing agent are provided to the injection molding machine as solid pellets.

6. The method of claim 1 wherein the first injection mold cavity is formed by a first mold portion and a second mold portion that are moved relative to each other between an open position and a closed position, wherein in the closed position the shape of the substrate portion is defined.

7. The method of claim 6 wherein the second injection molding cavity is formed by the first mold portion of the first injection mold, the substrate portion of the trim panel, and a third mold portion.

8. A mold for forming an interior component of a vehicle comprising:
a first injection mold having a first mold portion and a second mold portion that are moved relative to each other between an open position and a closed position in which the shape of a substrate portion is defined, wherein the first mold portion has at least one port for injecting a first polymeric material;
a second injection mold including the first mold portion of the first injection mold, the substrate portion of the trim panel that is formed by the first polymeric material, and a third mold portion, wherein the third mold portion has at least one port through which a mixture of a second polymeric material and a blowing agent are injected, the mixture being heated under pressure, wherein the mixture forms a smooth surface upon contact with the third mold portion and the mixture forms an expanded core as the blowing agent expands in an interior portion of the second injection mold.

9. The mold of claim 8 wherein the first material is a thermoplastic material that forms a relatively rigid substrate portion.

10. The mold of claim 8 wherein the second material is a thermoplastic elastomer.

11. The mold of claim 8 wherein the first mold portion of the second injection mold cavity while supporting the substrate portion is moved relative to the third mold portion between an open position and a closed position to define a cavity for the formation of an elastomeric foam padded portion having a smooth skin on the exterior surface of the padded portion.

12. A vehicle trim assembly, comprising:
a substrate member;
a padded cover member integrally molded onto the substrate member, the padded cover member having a smooth skin encompassing an expanded core, wherein the material used to form the smooth skin and the core is a mixture of an elastomer and a blowing agent that are melted under pressure in an injection molding machine.

13. The vehicle trim assembly of claim 12, wherein the substrate member is formed form a first material that is a thermoplastic material that forms a relatively rigid substrate portion.

14. The vehicle trim assembly of claim 12, wherein the elastomer is a thermoplastic elastomer.
